(19) United States
(12) Patent Application Publication
(10) Pub. No.: US 2011/0157609 A1
(43) Pub. Date: Jun. 30, 2011

(54) Systems and methods for processing online and print material

(76) Inventors: David Brady, London (GB); Tufan Unal, London (GB); Robin Stephens, Bedfordshire (GB); Paul McAsey, Surrey (GB)

(21) Appl. No.: 12/655,498

(22) Filed: Dec. 31, 2009

(51) Int. Cl. G06K 15/02; G06F 17/00; G06F 15/16

(52) U.S. Cl. 358/1.6; 358/1.2; 715/208; 709/206; 715/255

(57) ABSTRACT

The present invention relates to systems and methods for compiling communication material across a range of formats. A first aspect of the present invention relates to a method of editing an image for printing. The image data for a high resolution image is stored and the image is displayed at a lower resolution. The user can then edit the displayed image and image modifier data is generated based on the editing performed by the user. The image modifier data is subsequently applied to the stored high resolution image data and a modified version of the image is output based on said modified high resolution image data. The present invention also relates to a system and method for monitoring an electronic file. Furthermore, the present invention relates to a system and method of sharing data across a range of different templates for online and print material. The invention also relates to a system and method of generating online and print material in a common file format.

### FIELD OF THE INVENTION

The present invention relates to systems and methods for compiling communication material across a range of formats. More specifically, the present invention relates to systems and methods of preparing online and print material. The present invention also relates to a system and method for tracking an electronic file.

### BACKGROUND

It is known to provide software packages for developing online websites and applications. A website can be created from a template and the desired user content inserted in defined fields. The software typically enables changes to be made to the appearance and functionality of the website. The software may, for example, comprise a range of templates for creating new websites. However, known software packages are focused on developing online material and are not suitable for developing corresponding print materials, such as brochures, newsletters and leaflets. Thus, print materials have to be generated separately from the online materials. This can prove time consuming and often requires the duplication of effort.

A further problem arises due to the different requirements for online and print material. This is particularly evident in the context of image handling whereby a high resolution image is required to provide acceptable image print quality, for example in a printed brochure. However, the resulting image file sizes are relatively large and transferring them over a network can prove time consuming. Thus, displaying an image at a sufficiently high resolution for printing may slow the website due to the time required to upload images.

Furthermore, it is known to track the usage of a website, for example to determine the number of times the website is accessed. However, this is typically determined in isolation and it can prove difficult to determine the success of external factors, such as a marketing or advertising campaign. This limitation of current systems has been recognised by the inventors and efforts have been made to provide improved transparency.

The present invention, at least in preferred embodiments, attempts to overcome or ameliorate the problems and/or limitations of known systems.

### SUMMARY OF THE INVENTION

Viewed from a first aspect, the present invention relates to a method of editing an image, the method comprising the steps of:

(a) storing image data for a high resolution image;

(b) displaying the image at a lower resolution than said stored image data;

(c) generating image modifier data responsive to editing performed by a user on the displayed lower resolution image;

(d) applying the image modifier data to the stored high resolution image data; and

(e) outputting a modified version of said image based on said modified high resolution image data.

The display image is a lower resolution version of the stored high resolution image thereby allowing the user to make any desired changes. However, by displaying the image at a reduced resolution, the image data for the lower resolution display image (referred to herein as the lower resolution image data) is less than the stored image data for the high resolution image. The lower resolution image data can be transferred over a network more readily.

The image is preferably displayed at a sufficiently high resolution to enable the user to make accurate modifications. The image modifier data generated in response to the onscreen user changes can be applied to the high resolution image data to produce a final image, for example to be printed.

The image modifier data could be applied to the high resolution image in real time responsive to changes made by the user. The image modifier data could, for example, be transferred over a network and applied to the stored image data in real time. Preferably, however, the image modifier data is applied in a single step. The high resolution image data could be modified by application of the image modifier data in response to a user request, for example to enable onscreen verification of the changes. In preferred embodiments the image modifier data is applied automatically, for example when the user saves the changes or sends the image to a printer.

The lower resolution display image data could be independent of the high resolution image data, for example derived independently from a source data file. Preferably, however, the lower resolution display image data is derived from said high resolution image data. The step of displaying the image at step (b) can also include the step of deriving a lower resolution image from the stored image data. The display image can, for example, be generated by reducing the resolution of the stored high resolution image data. The lower resolution image data can be stored for display either local or remotely.

At least in preferred embodiments, the lower resolution image data can more readily be transferred over a network than the high resolution image data. The network could be a local area network (LAN), a wide area network (WAN) or the internet. Thus, the high resolution image data can be stored remotely and only the lower resolution image data transferred over the network for display.

The image modifier data can include data relating to one or more of the following: image cropping, image re-scaling, image rotation, image grading or image colouring. The image modifier data can also include data relating to changes to the file type, for example to convert from red green blue (rgb) to cyan magenta yellow key (cmyk) formats for printing. The image modifier data can include cut, paste or other modifier instructions. The image modifier data can also include the addition of text to the image.

The modified version of the image could be output into a high-resolution electronic file. Preferably, however, the modified version of the image is output for printing. The method preferably comprises the step of outputting the modified image to a printer. The modified high resolution image data can be formatted automatically for a detected printer type.

The image modifier data can be stored separately from the image data. This is advantageous since any changes can be cancelled by reverting to the original image data. Alternatively, the image modifier data can be applied and the resulting modified high resolution image stored.

Viewed from a further aspect, the present invention relates to a method of tracking an electronic file containing a first link to a first website, the method comprising the steps of:

(a) generating an unique identifier for identifying the electronic file;

(b) storing said unique identifier in a database;

(c) modifying the electronic file by replacing the first link with a second link to a host website;

(d) determining the unique identifier associated with the electronic file when the host website is accessed via the second link; and

(e) matching the unique identifier determined at step (d) to the unique identifier stored in the database to track the electronic file.

By matching the unique identifier for the electronic file with the unique identifier stored in the database, it is possible to determine one or more of the following: which user has followed the link; which electronic file the user has received; and which link has been followed. Thus, the electronic file can be tracked.

The unique identifier is preferably stored in the electronic file so that it can readily be matched with the unique identifier(s) stored in the database. The step of determining the unique identifier can comprise extracting the unique identifier from the electronic file.

The method preferably includes the step of directing a user from the host website to the first website. This step is preferably performed automatically once the unique identifier associated with the electronic file has been determined.

The unique identifier preferably forms part of a query string. The query string can be incorporated into the electronic file.

The method can include the step of determining at least one characteristic of the first website associated with the first link before the step of modifying the electronic file. The step can include determining if the website is compatible with the system for implementing the present method. For example, the method can include the step of determining whether the website has been developed with the same software.

The electronic file could be any file incorporating a link to a website. For example, the electronic file could be a website, portable document format (PDF) file, or a Word® document. Preferably, the electronic file is an electronic mail message (an “email”). The method preferably includes the step of sending the electronic mail message after it has been modified. The unique identifier is preferably also suitable for identifying the address to which the electronic mail message is sent. At least in preferred embodiments, the user accessing the first website can be ascertained from the address to which the electronic mail message is sent.

The method can include determining the number of computers accessing the first website related to the first link during a given period of time.

The method preferably comprises linking the unique identifier to an electronic mailing address to which the electronic mail message is sent. The electronic mailing address and the unique identifier can be indexed for future reference.

The first link and/or the second link can be in the form of a uniform resource locator (url) or can be embedded within the electronic mail message.

The method can include the further step of monitoring access to the first website during a given period of time. The method can, for example, determine the number of computers accessing the first website during the course of a day. The method can include the step of recording a time at which the website is accessed by each computer and/or the length of time over which the website was visited.

The website usage can be displayed graphically, for example in a chart as a function of time.

Viewed from a further aspect, the present invention relates to a method of sharing data across a range of different templates, the method comprising:

(a) generating a first identifier tag to identify a first data set as having a first content type;

(b) flagging one or more fields in each of said templates as relating to said first content type; and

(c) populating each field flagged in the templates as having said first content type with said first data set.

The method allows a set of templates to be modified simultaneously. At least in preferred embodiments, the templates generate one or more of the following: a website, an electronic publication, a printed publication, a newsletter and an e-mail. Preferably, a plurality of user-selectable templates is provided for each of the different material formats. The method thereby allows templates for both online and print materials to be modified at the same time. The changes are preferably implemented in each of the templates in real time.

The method steps (a) to (c) are preferably repeated for a plurality of data sets. The data sets can each have a different content type and a unique identifier tag is generated for each data set. The data sets could relate, for example, to company information, personnel details, news items, forthcoming events etc.

The changes to each data set are preferably updated automatically in each field flagged as relating to that content type. The update is preferably performed in real time.

The data set can comprise one or more of the following: image data, animation data and text data. The changes to the first data set can include modifying image data.

Viewed from a yet further aspect, the present invention relates to a method of generating online material and print material, the method comprising the steps of:

(a) selecting a first template for the online material and a second template for the print material;

(b) modifying one or more data sets in said first template and/or said second template using a common editor to generate the online material and the print material; and

(b) outputting the online material and the print material in a common file format for storage.

A single editor can be used to edit the online and print material thereby avoiding the need for the user to learn how to use two different editing tools. Moreover, the method allows the online and print material to be stored in a single, common file format. Thus, the online material and the print material is stored digitally in the same file format. Preferably, both the online and print material are stored in html format. The online material is typically a website accessible over the internet. The print material is material to be printed, for example a brochure or newsletter.

The method can also be used to generate an electronic file, such as a electronic newsletter or brochure. The method can comprise the step of selecting a third template for the electronic file. The electronic file is preferably also generated in said common file format.

The online material, the print material and/or the electronic file can be stored on a storage device.

Viewed from a further aspect, the present invention relates to a system for editing an image for printing, the system comprising a storage device for storing image data for a high resolution image; a display for displaying the image at a lower resolution than said stored image data; a data generator adapted to generate image modifier data responsive to editing performed by a user on the displayed lower resolution image; a processor operative to apply the image modifier data to the stored high resolution image data; and an output device for outputting a modified version of said image based on said modified high resolution image data.

Viewed from a still further aspect, the present invention relates to a system for tracking an electronic file containing a first link to a first website, the system comprising at least one processor adapted to generate an unique identifier for identifying the electronic file and to modify the electronic file by replacing the first link within the electronic file with a second link to a host website; a storage device for storing said unique identifier; and processing means adapted to determine the unique identifier associated with the electronic file when the host website is accessed via the second link; the processing means also being adapted to search the database to identify the determined unique identifier.

Viewed from a yet further aspect, the present invention relates to a system for sharing data across a range of different templates, the system comprising a tag generator for generating a first identifier tag to identify a first data set as having a first content type; at least one processor for flagging one or more fields in each of said templates as relating to said first content type; wherein the at least one processor is operative to populate each field flagged in the templates as having said first content type with said first data set.

Viewed from a yet still further aspect, the present invention relates to a system for generating online material and print material, the system comprising a storage device on which at least a first template for online material and a second template for print material are stored; processing means adapted to enable one or more data sets in said first template and/or said second template to be modified using a common editor to generate the online material and the print material; the processing means being adapted to generate the online material and the print material in a common file format. The online material and the print material are preferably both stored in html format.

References herein to print material are to material which is to be output to a printer for printing. References herein to online material are to material which is to be output electronically over a network, typically the internet.

The present invention can be implemented on a computational electronic processor. The required operating instructions can be provided in hardware or software. Preferably, the operating instructions are provided in software to control a general purpose electronic processor to operate in accordance with the present invention. The present invention also relates to a system adapted to operate the methods described herein. Furthermore, the present invention relates to software provided on a machine-readable medium to cause an electronic microprocessor to operate in accordance with the method described herein.

### BRIEF DESCRIPTION OF THE FIGURES

A preferred embodiment of the present invention will be described, by way of example only, with reference to the accompanying figures, in which:

FIG. 1 is a screen dump of a system according to the present invention showing a plurality of templates for a website;

FIG. 2 is a screen dump of a system according to the present invention showing the re-scaling of an image;

FIG. 3 is a screen dump of a system according to the present invention showing text being added to an image;

FIG. 4 is a screen dump of a system according to the present invention showing different email templates;

FIG. 5 is a screen dump of a system according to the present invention showing a plurality of templates for a printed brochure; and

FIG. 6 is a screen dump of a system according to the present invention showing text being edited for a printed brochure.

### DETAILED DESCRIPTION OF A PREFERRED EMBODIMENT

A system according to a preferred embodiment of the present invention will now be described with reference to the accompanying figures. The system provides the user with a template selector, a file manager, a text and image editor, a form editor, an online manager, an email manager and a print manager.

The system is implemented on a computational device having at least one electronic microprocessor. The computational device is programmed to operate in accordance with the present invention by software which can be accessed over the internet.

The online manager allows the user to create and edit online content, including websites, and post the results on the internet. The email manager is used to create and format emails, for example to be sent to individuals who have subscribed to an online update service. The print manager is used to create printed literature such as brochures and newsletters. The online, email and print managers can all be linked allowing changes in one data set to be applied to each different format.

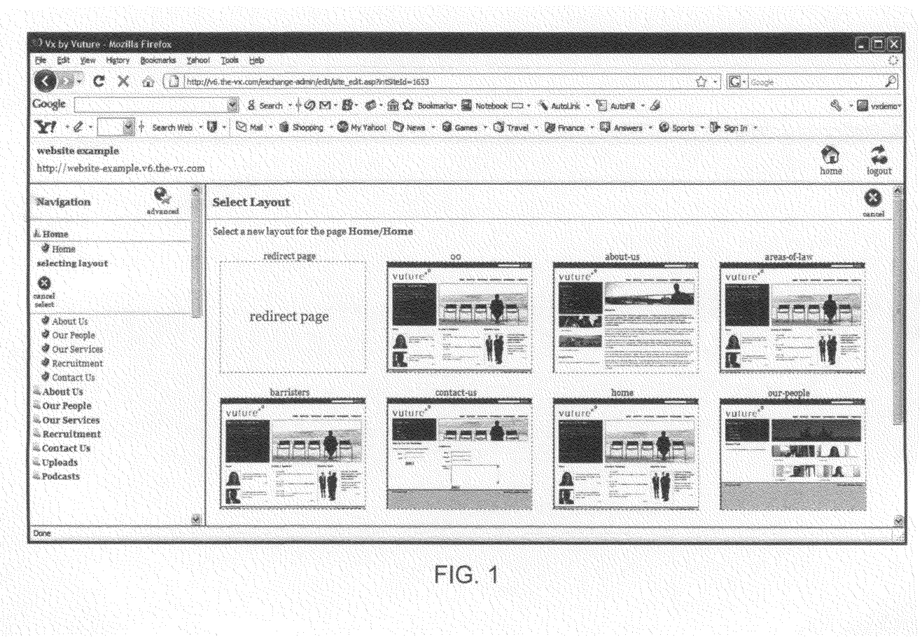

The template selector provides the user with a series of templates for creating websites and print material, such as printed brochures and newsletters. The templates each have a plurality of entry fields into which data, such as text and images, is inserted. The entry fields are arranged in different layouts in each of the templates, as illustrated in FIG. 1 which shows several templates for a website.

The user can select a template having entry fields arranged in a suitable layout for the task in hand. The user can then populate the entry fields with customised data, such as photographs and text. The user can refine the layout by changing the size and/or location of the entry fields in the template using suitable layout editing tools. A summary of the editing tools available for editing a draft website is provided in Table 1 below.

TABLE 1

| Action | Description |
|---|---|
| view page | Opens the current view of the page (live, draft or hidden) in a new window. |
| publish page | Publishes a draft or hidden page to the internet. The page is automatically |
| | displayed in any menus or sub-menus generated from that folder. |
| send for | Publish page is not available to editors as they cannot publish directly to |
| approval | the internet. Instead, editors use the send for approval button to send an |
| | email to selected publishers who can then review and publish the page. |
| show live | Shows the live version of the page. |
| show draft | Shows the draft version of the page. |
| hide page | Hides the page from the internet. The page is automatically removed from |
| | any menus or sub-menus. The page can still be edited. |
| delete | Deletes a page or folder from the system. All pages inside the folder are |
| page/folder | also deleted. This cannot be undone. |
| rename page | Renames a page or folder. All folders and all pages within a folder must |
| | have a unique name. |
| move page/folder | Moves a page or folder to another location in the site structure. Pages can |
| | be moved within a folder or to a different folder. Menus and sub-menus are |
| | automatically updated to reflect the change. |
| copy page | Makes a copy of the current page directly underneath. This page is hidden |
| | by default. |
| select layout | Provides a thumbnail list of alternative layouts for the page. Selecting a |
| | new layout overwrites all content on the page. |
| edit layout | Switches into edit layout mode. This allows elements of the page to be |
| | dragged around the layout, deleted and new elements inserted. |
| page history | Displays a log of when a page was published and by whom. You can view |
| | any previous version of the page by clicking preview and roll back to that |
| | version by clicking restore. |
| page options | Manage page descriptions and meta tags for each page. |

The image editor is suitable for editing images to be incorporated into the website or print material. The image editor allows the user to select a new image from an image library. The image can then be cropped, resized and/or edited for insertion into the desired entry field, as described in more detail below.

Images are stored on a storage device and can be uploaded and managed in the image library. A folder within the image library is opened and the required image is selected from the list of thumbnails displayed. The name and size of the image is displayed in the image library and images can be rotated within the image library. The image library also enables file handling, such as deleting images and folders which are no longer required. Moreover, new folders can be created and named by a user.

Images can be uploaded to the image library by selecting an upload link. Multiple images can be selecting by the user and then uploaded into the image library simultaneously. Additional images can be uploaded at any time. Moreover, the user can upload modified images to the image library for future use. For example, the user may edit an image and then upload the modified image to the image library. Images can be in jpg or gif format and should be uploaded at as high a resolution as possible. Individual file size upload limit is 30 Mb but file sizes should preferably be kept below 5 Mb for best results.

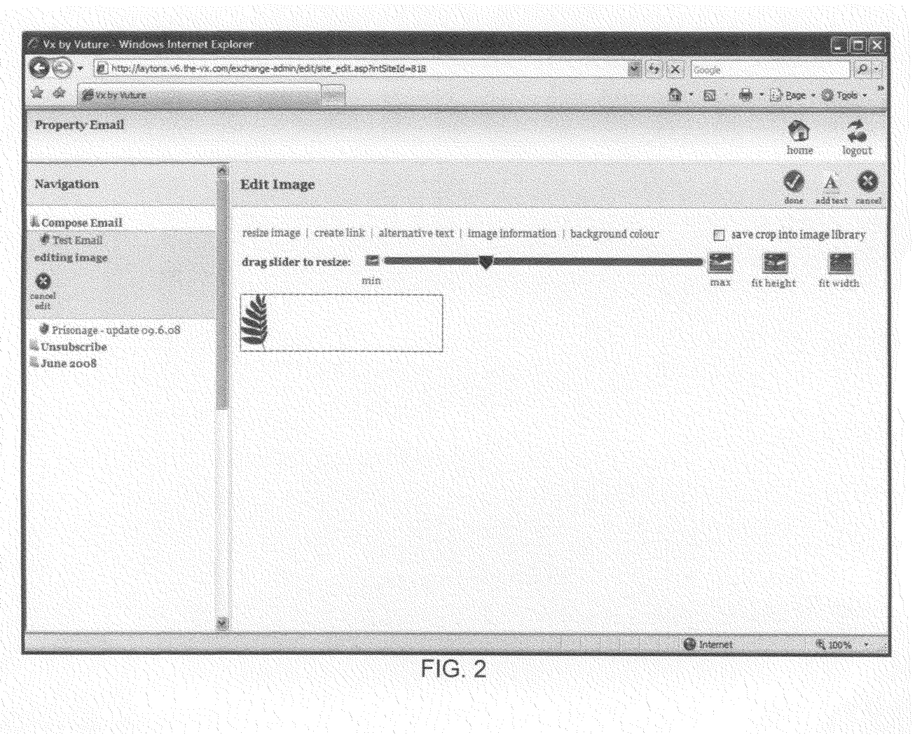

The editing of the images by a user will now be described. Only some images may be editable by a user, for example based on user access rights. The system provides an indication as to which images can be edited. In the present embodiment, those images that can be modified are faded out. Once a new image is selected for insertion into an entry field, the system will automatically resize the image to fit the space available. As illustrated in FIG. 2, the image size can be further refined by dragging the slider bar or using “max”, “fit height” and “fit width” options automatically to resize the image. The image can also be cropped by selecting a portion of the image within a crop box.

The system also allows a background colour within the image to be selected. A background colour for the website can then be matched to a corner of the image. This is particularly useful when an image is cropped and is not displayed on a white background. There are some additional colour selection options and these are summarised in Table 2 below.

TABLE 2

| Name | Action | Notes |
|---|---|---|
| Logo | Use logo for | Allows the user to use the logo to directly |
| | colours | select colours to apply on the site |
| Colour | A full pallet of | Allows the user to select additional colours |
| Picker | colours | by dragging the mouse over the colour array |
| Swatch | Pre saved colours | Allows the user to select from your pre- |
| | | saved brand colours or any you save with |
| | | the add to swatch function |
| Code | Colour code | Allows the user to type an ‘RGB’ colour |
| | | code if known |

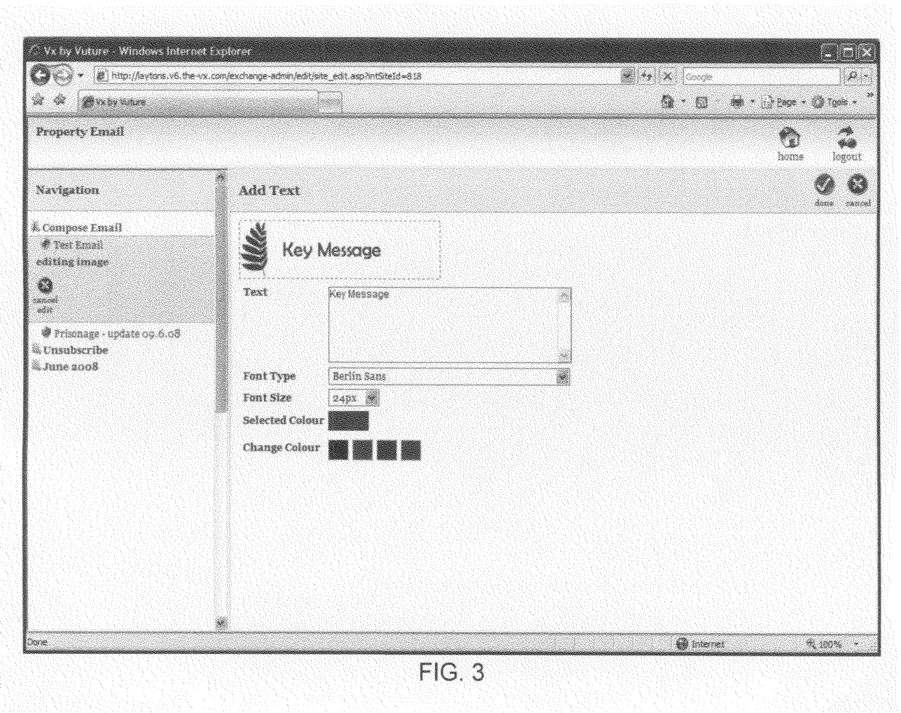

As illustrated in FIG. 3, the user can also insert non-web text to an image, for example to insert a message. The user types the text into an entry field and then positions it over the image. Once the desired font, size and colour have been selected, the text is added in directly as part of the image and cannot be read by search engines. Any TrueType or Open Type font can be used as long as it is installed on the web server and is not required on the client computer.

Further image editing options include creating links to turn the image into a link to another website. A descriptive text can be added for an image, for example to be displayed when the onscreen cursor is positioned over the image. This is useful for visually impaired website users, visitors with images switched off and for search engines. Also, an image information option is provided to display the dimensions and/or file size of the image.

Once the user is satisfied with the image editing, the modified image can be saved to the image library and is then available for future use. All pages are based on layouts provided as part of the website template. However, the layout of a page can be changed at any time by picking a different standard layout or by customising the layout using the edit layout function. The method of choosing and editing a page layout will now be described.

The user selects the page having a layout to be changed. The user then chooses the select layout option and is presented with a list of all the standard page layouts available. The user selects the desired layout and the page is automatically updated. The text and image data from the previous page is automatically inserted into corresponding entry fields in the new page. The page is automatically put into draft mode when a new layout is selected and, once satisfied with the changes, the user can accept the changes.

The system is provided with an edit layout function which allows the user to re-organise content on the page using drag and drop. Content can also be removed from the page; existing content copied; and new elements inserted onto the page. Depending on user access level and enabled functionality, there are also a number of advanced options available and these are summarised in Table 3 below.

TABLE 3

| Item | Description |
|---|---|
| Publish multiple | Provides a list of all draft pages. Multiple pages can be published by |
| pages | ticking those to be published and clicking publish selected pages. |
| Site log | The log is updated each time a page is published and displays when |
| | the page was published, by whom and the version number. Click on the |
| | page name to view that version of the page in a new window. |
| Site map | If the site map function is enabled this allows the user to select which |
| | pages on the site should appear in the site map. Tick the required |
| | pages and click on update site map. |
| Site name & | This allows the user to change the name and primary domain for the |
| address | site. This should be used with care as the domain registration must be |
| | set up correctly before making any changes to the site address. |
| Additional | Enter any additional domains for this site. Note this only updates the |
| addresses | host headers on the web server and the user must point the A record |
| | for this domain to the IP address given on this page. |
| Colours | The colour scheme for the site can be changed if allowed by the |
| | template. |
| Check site | Checks the site for broken internal and external links. |

The email manager allows the user to create new emails, edit them and send them to email lists. The email manager also displays a history of all sent emails and lets the user manage unsubscribe pages where a recipient indicates that they no longer wish to remain on an emailing list.

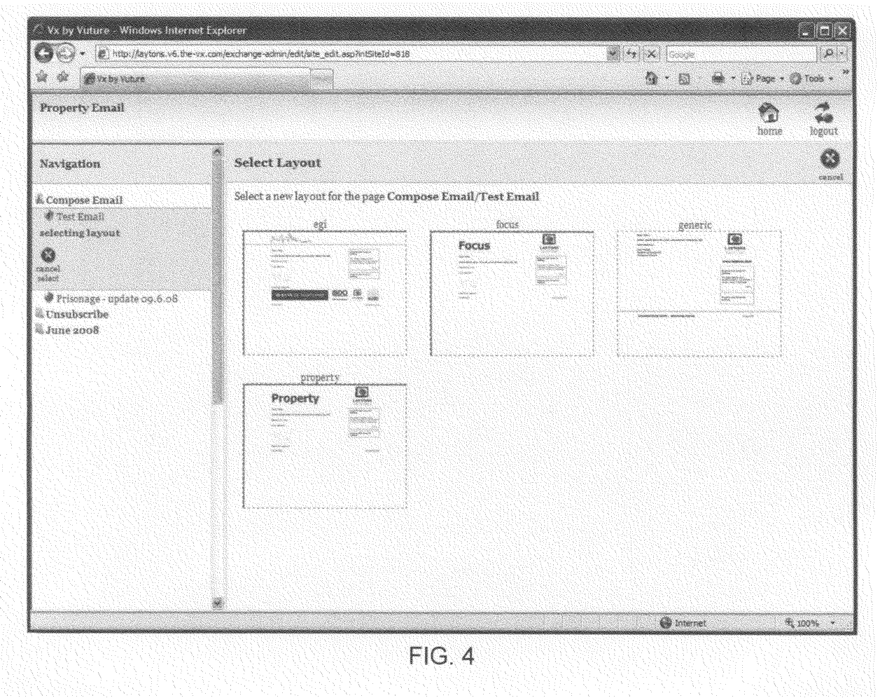

To compose an email, the email manager opens initially in the compose email screen and, as illustrated in FIG. 4, a selection of email layout templates are displayed. In the present example there are four layouts—egi, focus, property and a generic email. The user can then enter a name for the new email and then create a new email by clicking on the desired thumbnail.

The layout of the email can then be re-organised using drag and drop options. Moreover, the user can remove content from the email, copy existing content and insert new elements into the email. Those features of the email that can be edited (e.g. by selecting them and dragging them around the page) are highlighted by fading them out when the cursor passes over them. In addition to delete, copy and insert options, an option to add a selected block to a snippets library is provided to enable the currently selected block to be stored in the snippets library for re-use in other emails. The various email options are summarised in Table 4 below.

TABLE 4

| Action | Description |
|---|---|
| view email | Opens the current view of the email (live or draft) in a new window. |
| publish email | Publishes a draft email ready to be sent. |
| send for | Publish email is not available to editors as they cannot email without |
| approval | approval. Instead, editors use the send for approval button to send an |
| | email to selected publishers who can then review and publish and/or send |
| | the email. |
| show live | Shows the live version of the email. |
| show draft | Shows the draft version of the email. |
| delete email | Deletes an email from the system. |
| rename email | Renames an email. All emails in a particular folder must have a unique |
| | name. If the user sends an email with a duplicate name in the same month |
| | the system will automatically number them. |
| copy email | Makes a copy of the current email directly underneath. |
| select layout | Provides a thumbnail list of alternative layouts for the email. Selecting a |
| | new layout overwrites all content on the email. |
| save layout | Places the layout the user have created in the folder of thumbnails for the |
| | user to choose when composing a new email or selecting a new layout. |
| edit layout | Switches into edit layout mode. This allows elements of the email to be |
| | dragged around the layout, deleted and new elements inserted. |
| email history | Displays a log of when an email was published and by whom. The user can |
| | view any previous version of the email by clicking preview and roll back to |
| | that version by clicking restore. |
| send email | Takes the user to the email sending options for the current email. |

When the user is satisfied with the content and layout of the email, it can be sent to the named recipients. Once an email has been sent clicking on it displays the email history. The email history displays one or more of the following summary information:
Total number of emails sent;
Time of the emails sent to the first and last person on the list;
The total number of emails that have been opened;
The total number of links that have been clicked—if a recipient clicks on the same link more than once then each click is counted; and
The total number of unsubscribes.

Furthermore, for each person who was sent the email, the system history displays one or more of the following:
The recipient's email address;
The name of the list that was sent to;
The date and time the email was sent;
The date and time the email was opened by the recipient;
The number of links in the email that the recipient clicked on; and
The date and time they unsubscribed, if any.

The email manager also allows emails to be manually added to a selected list; imported by uploading one or more Comma Separated Values (CSV) files; and subscriber details to be viewed and/or edited.

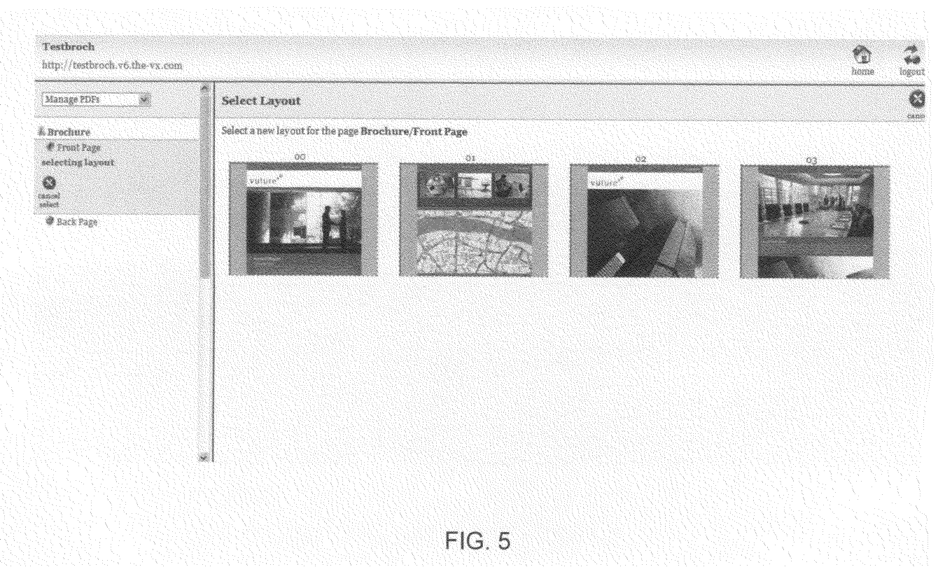

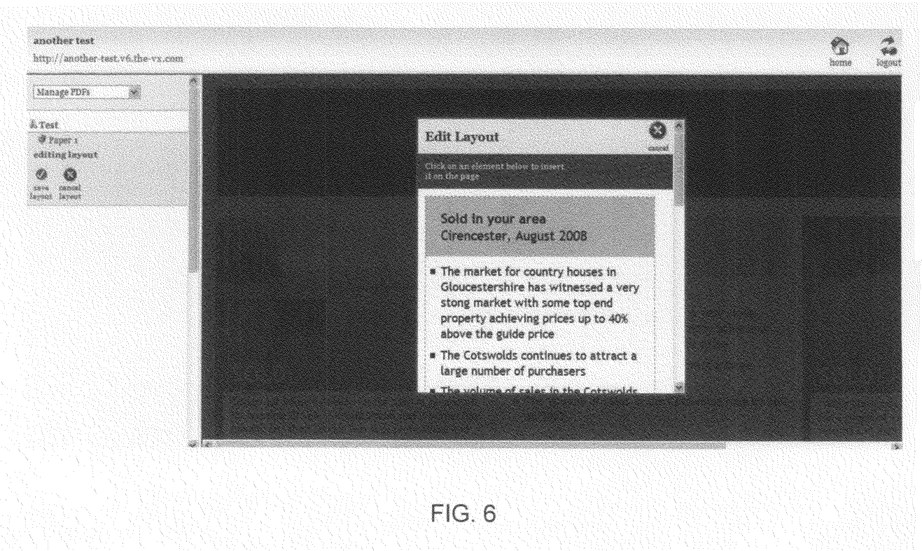

The print manager is provided to enable print material, such as brochures, to be edited. The operation of the print manager will now be described with reference to FIGS. 5 and 6.

The pages of the print material are based on layouts provided as part of the print template. The user can select a page layout from a plurality of standard templates, as illustrated in FIG. 5. The page layout can be changed at any time by selecting a different standard layout or by customising the layout using the edit layout function.

To choose a standard page layout the user chooses the “select layout” tab and is presented with a list of all the standard page layouts available. The required layout can be selected by clicking on the desired thumbnail image and the page is automatically updated. The page is automatically put into draft mode when a user selects a new layout.

As illustrated in FIG. 6, the edit layout function allows the user to re-organise content on the page by selecting entry fields and dragging them around the screen and dropping them in the desired location. The edit layout function also allows the user to remove content from the page, copy existing content and insert new elements onto the page. Furthermore, the currently selected block can be added to a snippets library for re-use across the site.

A summary of the page editing functions for the print manager is provided in Table 5 below.

TABLE 5

| Action | Description |
|---|---|
| view page | Opens the current view of the page (live, draft or hidden) in a new |
| | window. |
| publish page | Publishes a draft or hidden page to be used. |
| send for approval | Publish page is not available to editors instead, editors use the send for |
| | approval button to send an email to selected publishers who can then |
| | review and publish the page. |
| delete page/folder | Deletes a page from the system. This cannot be undone. |
| rename page | Renames a page. All pages must have a unique name. |
| move page/folder | Moves a page to change the order of the pages. |
| copy page | Makes a copy of the current page directly underneath. This page is |
| | hidden by default. |
| select layout | Provides a thumbnail list of alternative layouts for the page. Selecting a |
| | new layout overwrites all content on the page. |
| edit layout | Switches into edit layout mode. This allows elements of the page to be |
| | dragged around the layout, deleted and new elements inserted. |
| page history | Displays a log of when a page was published and by whom. The user |
| | can view any previous version of the page by clicking preview and roll |
| | back to that version by clicking restore. |

The print manager includes text editing and image editing functions equivalent to those outlined above for the online manager. For the sake of brevity, these functions will not be described again.

The underlying technical features of the system according to the present invention will now be described.

### Tagging

The system allows users to manipulate web, email and print-based content using a standardised and easy to use interface. The web, email and printed page are each based on a standardised layout that has been marked up (lagged') to identify the editable areas.

The system layout is an HTML template that has been marked up using a set of Cascading Style Sheet (CSS) class tags that mark the editable areas within the template. The layouts are based on standard HTML pages and existing web pages or emails can be used as the base for a layout. Print layouts are converted from flat designs into an HTML representation of the page using millimetres for measurements.

The system layouts are tagged using CSS classes to indicate which areas of the layout are editable. The CSS classes are in the format vx_xxx where xxx=the type of editable area. Possible values are listed below but these can be extended to create additional types of editable area.
vx_text=editable text
vx_image=editable image
vx_menu=editable menu
vx_select=editable select
vx_form=editable form
vx_iframe=editable iframe
vx_block=draggable item
vx_drag=container for draggable items

### Selecting Editable Areas

The application of the vx_xxx CSS class marks an area of the page as being editable. When editing a page, the system applies a set of JavaScript observe events to the areas marked as vx_xxx. These observers cause the marked up element to fade out when the user places their cursor over it by using JavaScript to changing its opacity.

The onclick event passes the id of the tagged element to the appropriate editor using an Ajax call which allows the content to be read from the file system and displayed for the user to edit. When the editor has finished manipulating the content it is passed back to the page through an Ajax call, which displays the update without reloading the page and also writes the changes back to the file system.

The system according to the present invention uses its own custom JavaScript routines and parts of the Prototype and Scriptaculous JavaScript libraries to perform the various Ajax calls and to provide additional visual effects.

### Editable Text

Editable text areas are tagged by adding a CSS class of vx_text either directly to an HTML tag (p,h1,h2,h3,h4,h5,h6,ul,ol) or by adding the class of vx_text to a div or span tag that surrounds the text that can be edited.

Each HTML tag marked with a vx_text class should also have a unique id usually of the format txt_xxx where xxx is an integer. The text editor allows the content to be changed and previewed in place using an Ajax call which updates the contents of the element being edited. When the user clicks ‘update’ the contents of the text editor are written back to the page by performing a file read/write which replaces the selected element.

There are additional system ‘tags’ that can be applied to a vx_text area to perform additional functions. These are applied as additional classes in the vx_text tag.
vx_include_includename—allows editable text areas to be put into include files which can appear on more than one page. Updating the contents of one area automatically updates everywhere this appears on the site. This works by passing the includename from the vx_include tag so that the system knows which include file to update. The user is also notified that this is a global update.
vx_custom_theme=xxx—allows the editable text area to have a certain subset of text editing options available. xxx is the name of the set of text editing options and typical values are full, simple, none. This ‘tag’ controls which set of text editing toolbars are displayed when editing the text. This option can be changed by an administrator directly in the system without having to amend the underlying HTML.
vx_custom_maxchars=xxx—allows control over the number of non-HTML characters that can be inserted in the editable area. xxx is a positive integer with zero meaning unlimited characters. The system passes this value to the text editor which provides a character count and notifies the user when they go over the maximum number of characters.
vx_custom_group=xxx—allows control over who can edit a specific editable area. xxx is the name of the user group set up in the system.

### Editable Images

Editable images are tagged by adding a vx_image class to a div or span tag around an image. The vx_image HTML tag should also have a unique id usually in the format img_xxx where xxx is a positive integer. Marking an image as editable allows a user to manipulate or change the image using the image editor. The image editor allows the user to select a new image from one of the system image libraries or choose to manipulate the existing image.

A crop box is provided in the image editor that is the same size as the image placeholder in the page templates. The image can be resized using a drag handle which calls a JavaScript function to scale the image on the page. The crop box can be dragged and dropped to position it on the page using JavaScript allowing the user to select all or part of the image. Once the appropriate part of the image has been highlighted using the crop box and drag handle it can be cropped onto the page. This happens by passing the x and y co-ordinates of the crop box and the scale factor provided by the drag handle. The system calculates where the crop should be taken from in the image. The image is cropped using server-side code and this is saved as a new image and the src attribute of the img tag is updated on the HTML page to reflect this.

An additional class of vx_image_flexible can be applied to any vx_image tag. This allows the crop box to be expanded or contracted in the vertical direction when cropping the image. In this way the image always fills the column width in the page layout but the proportions of the image placeholder can be varied from portrait to square to landscape to accommodate images of different shapes. This is used to keep the design integrity of the page but provides more flexibility. The vx_image_flexible_both tag allows the crop box to be expanded horizontally as well as vertically and is usually only used in flexible print layouts.

The flexible image functionality is achieved through additional JavaScript functions that allow the crop box to be resized and pass the appropriate x, y co-ordinates to the server-side script performing the image crop. The underlying HTML page requires no change to the CSS controlling the image size since the width and height are not passed for flexible images but are instead determined by the physical size of the image.

### Editable Menus

The vx_menu tag is applied as a CSS class to a div tag surrounding an unordered list (ul) that contains a set of links used for navigation. This set of links is automatically generated from a folder in the system site tree.

The system automatically keeps a list of all pages in each folder as a separate unordered list held in an include file that is labelled to match the unique id of that folder. Each of these include files is kept up to date in real time.

Clicking on an area tagged as vx_menu displays a list of all the folders in the system site structure. A folder can be selected and the editable area is replaced with a set of links to the pages in that folder This happens through an Ajax call that passes the id of the vx_menu area to the menu editor. A folder is selected and this is passed to a server-side process that updates the page using a server-side file operation. This tagging is used for site navigation and is a quick of way of displaying a set of links on a page. It is also automatically updated each time the pages in that folder change in anyway e.g. are renamed, deleted, added to or re-ordered.

### Editable Selects

The vx_select tag works in exactly the same way as vx_menu but generates a drop down list with the links to the selected pages. Selecting an item in the drop-down list automatically navigates the user to that page.

### Editable Forms

The vx_form tag is applied as a CSS class to a div tag that surrounds an editable form. Clicking on an editable form in the system passes the id of the vx_form tag to the system form editor.

The form editor renders the form on the page and allows the user to edit the field name/label, field type and add additional instructions. The form fields can be dragged and dropped to re-order. Form fields can be added and removed from the form. The form fields are stored in the form with special ids that are prefixed with vx_and include the name of the form field to identify them.

The form editor uses JavaScript to allow the user to manipulate the form without having to reload the page. Each form field update activity writes the change directly to the page by accessing the DOM. When the form is saved the updates are written server-side to the HTML file using Ajax.

All forms are submitted to a system form handler page. This reads the form and its fields and writes the details to a database with details of the user completing the form including IP address and user agent.

Editable iFrame

The vx_iframe tag is used as CSS class applied to a div tag surrounding an editable iFrame. Clicking on an editable iFrame passes the id of the vx_iframe div tag to the iFrame editor. The iFrame editor parses the iFrame tag to get the source and height of the iFrame. The source and height are editable from the iFrame editor. Updates to them are written back to the HTML file through a server side read/write operation.

### Drag and Drop

Elements on web, email or print pages can be marked up for drag and drop by using the vx_block and vx_drag tags. Any area of content on the page can be marked as draggable by surrounding it with a div tag with a CSS class of vx_block. This div tag should have a unique id usually of the format blk_xxx where xxx is a positive integer. The containers within which draggable elements can be re-ordered are marked by surrounding them with a div tag with a CSS class of vx_drag. This div tag should have a unique id usually of the format col_xxx where xxx is a positive integer. All elements inside a vx_drag draggable container should be within a vx_block.

Any number of draggable containers can be provided on a page. The draggable elements can be defined as to whether or not they can be moved between different draggable containers or can only be moved within their parent container by setting the constraint setting to true or false respectively. Draggable elements can be styled differently within draggable containers which allows them to automatically restyle through the CSS as they are moved between containers.

The drag and drop functionality uses custom JavaScript code that makes calls to the Prototype and Scriptaculous JavaScript libraries for the underlying draggable functionality. To drag and drop content on a page a user must first enter edit layout mode using the button next to the page name.

When edit layout mode is entered, the system creates a Scriptaculous sortable for each draggable area marked on the page. It also makes each draggable element fade out as the cursor passes over it so the user knows what can be dragged on the page. When a user drags an element to a new location an Ajax call is made to update a temporary page that is created when edit layout mode is entered. Right clicking on a draggable element brings up a JavaScript context menu. This menu allows the element to be deleted, copied or a new element to be inserted below.

The context menu is displayed through a JavaScript event that is attached to the vx_block element when edit layout mode is entered. Deleting the element uses JavaScript to remove it from the DOM so it disappears from the displayed page automatically. An Ajax call is also made to update the temporary file to remove it. Copying an element uses JavaScript to insert a copy of the element directly below it in the DOM. An Ajax call is also made to update the temporary file to add a copy.

Inserting below brings up an HTML file containing a list of elements that can be inserted into that vx_drag area. These are displayed from either a default HTML with all general elements that are available or, if it exists, from a custom HTML file that displays elements that are suitable just for that draggable container. The custom HTML file is named to match an optional additional CSS class added to the vx_drag called vx_blocks_file_xxxx where xxx=the name of the custom HTML file. Whichever element is chosen from the HTML file is inserted below the current element using the mechanism described above. Each element in the HTML file is marked as a vx_block.

When a user chooses to save the layout the temporary file is written over the currently active file to save the changes.

### Low-Res/Hi-Res Image Swap

When updating images in a print material, the system inserts a web resolution version of the file onto the page. It also generates a high resolution version of the image that is replaced when the page is generated for high resolution print.

When images are uploaded into the system, three versions are stored. The original upload is saved at full resolution, a 96 dpi web resolution version is created for manipulation within the system and a thumbnail version is created for displaying in the image library.

When a user edits an image in a print material, the 96 dpi web resolution version is displayed. When a user has selected their chosen crop the web version is resized and saved into the material as described in the image editing section. At the same time the x,y co-ordinates and scaling factor are recalculated for a 300 dpi print material. The system crops the high-resolution version of the image as close to 300 dpi as possible and saves it into a high resolution image folder with the same name as the web version that had been cropped into the page for viewing.

When the print material is converted to a high resolution PDF from its system HTML version any image that has a high resolution version is swapped during this process to provide print-ready artwork. This is achieved by inserting the high resolution image at 3.125 times the size of the web version into the HTML page (300/96 dpi=3.125). When the web page is converted to a PDF this results in a 300 dpi high resolution version of the image appearing in the PDF document.

### Email Tracking

When an email is sent out using the system according to the present invention, all links in the email are replaced with a handler page URL and a querystring containing a unique email identifier which identifies both the email and the email address it was sent to in the system database.

When a user receiving an email clicks on a link they are taken to a system handler page. This handler page reads the querystring which is matched to the email history in the system database. The handler page then records who they are, which email they have received and which link they have clicked on in the system database before forwarding them to the link destination.

If the link destination is another system page or file then the unique identifier is added to all of the links on that system page by replacing them with the handler page and querystring as described above. If the user clicks on any link on this page their destination is tracked through the system and linked back to the original email.

As long as the user is making a journey across system websites (preferably those websites created using the system according to the present invention), email or PDF materials (which can also contain links with the system tracking code attached) then the system can track their full journey and make this accessible through built-in reporting tools.

### Material Creation

System materials can be created very quickly and easily from existing materials by using them as a base template and applying new branding. They can then be populated with new content and made available via web, email or print.

Any system material can be saved as a template. This is done from the advanced options and saves all the HTML files, images and other asset files such as PDFs to the template area with a specified name and the same file structure. It also generates a SQL file that can be run to regenerate the material in the database with exactly the same page structure.

When creating a new material, the underlying template is selected first. The user can then replace the logo area with a new image. The logo area is tagged up as vx_logo in the same manner as described in the editable areas. The user can then select a logo which can be previewed in the material before it is generated. This is done through an Ajax call to the template preview.

The colour scheme of the material can be changed using the system's colour editor. This allows the user to change the colour of any element of the material that has been tagged up in its CSS file. The CSS file tagging is of the format:

background: /*<edit title=“footer background”>*/#cccde2;r</edit>*/

where /*<edit title=“xxx”>* is inserted before the colour code to be changed and xxx=the name of the style that is displayed in the colour editor. The colour code should have /*</edit>*/ inserted after the trailing semicolon. The example above sets the CSS background colour style but this can be any CSS style that takes a colour code.

If the same colour is to be replaced in multiple locations in the CSS file then the same value for xxx should be used at each place in the CSS file. When viewing the template in the colour editor, the list of areas of the template that can be changed is available from a drop down list.

A new colour can be picked by extracting a colour from the selected logo. This is done through a JavaScript colour picker which can be dragged to any location in the logo to obtain the RGB colour. New colours can also be picked from a colour swatch or colour codes dialled in. Once the colour and area to be changed has been selected these can be previewed in the template. This is done by creating a temporary CSS file and replacing the colour codes. This temporary CSS file is applied to the template preview.

Once the new template has been selected, rebranded and named—the system generates a new material that is available immediately for a user to edit by copying the template file structure and running the associated SQL file to create the new database records.

The filename “vx” employed herein is proprietary and is not intended to be limiting.

It will be appreciated that various changes and modifications may be made to the present invention without departing from the present invention. The scope of protection conferred is defined in the appended claim set.

1. A method of editing an image, the method comprising the steps of:
(a) storing image data for a high resolution image;
(b) displaying the image at a lower resolution than said stored image data;
(c) generating image modifier data responsive to editing performed by a user on the displayed lower resolution image;
(d) applying the image modifier data to the stored high resolution image data; and
(e) outputting a modified version of said image based on said modified high resolution image data.

2. A method of editing an image as claimed in claim 1, wherein data for displaying the lower resolution image is derived from said high resolution image.

3. A method of editing an image as claimed in claim 2, wherein the data for displaying the lower resolution image is transmitted over a network.

4. A method of editing an image as claimed in claim 1, wherein said image modifier data includes data relating to at least one of the following: cropping, re-scaling, rotating, colouring, and changing the file type.

5. A method of editing an image as claimed in claim 1, wherein said image modifier data includes data to add text.

6. A method of editing an image as claimed in claim 1, wherein the modified version of said image is output to a printer.

7. A method of editing an image as claimed in claim 6, wherein the modified version of said image is automatically re-formatted to match said printer.

8. A system for editing an image for printing, the system comprising a storage device for storing image data for a high resolution image; a display for displaying the image at a lower resolution than said stored image data; a data generator adapted to generate image modifier data responsive to editing performed by a user on the displayed lower resolution image; a processor operative to apply the image modifier data to the stored high resolution image data; and an output device for outputting a modified version of said image based on said modified high resolution image data.

9. A method of tracking an electronic file containing a first link to a first website, the method comprising the steps of:
(a) generating an unique identifier for identifying the electronic file;
(b) storing said unique identifier in a database;
(c) modifying the electronic file by replacing the first link with a second link to a host website;
(d) determining the unique identifier associated with the electronic file when the host website is accessed via the second link; and
(e) matching the unique identifier determined at step (d) to the unique identifier stored in the database to track the electronic file.

10. A method as claimed in claim 9 further comprising the step of directing a user from the host website to the first website related to the first link.

11. A method as claimed in claim 9, wherein the unique identifier forms part of a query string.

12. A method as claimed in claim 9 further comprising the step of determining at least one characteristic of the website associated with the first link.

13. A method as claimed in claim 9, wherein the electronic file is an electronic mail message and the method includes the step of sending the electronic mail message after it has been modified.

14. A method as claimed in claim 13, wherein the unique identifier is also suitable for identifying the address to which the electronic mail message is sent.

15. A method as claimed in claim 9, wherein the number of computers accessing the website related to the first link during a given period of time is determined.

16. A system for tracking an electronic file containing a first link to a first website, the system comprising at least one processor adapted to generate an unique identifier for identifying the electronic file and to modify the electronic file by replacing the first link within the electronic file with a second link to a host website; a storage device for storing said unique identifier; and processing means adapted to determine the unique identifier associated with the electronic file when the host website is accessed via the second link; the processing means also being adapted to search the database to identify the determined unique identifier.

17. A method of sharing data across a range of different templates, the method comprising:
(a) generating a first identifier tag to identify a first data set as having a first content type;
(b) flagging one or more fields in each of said templates as relating to said first content type; and
(c) populating each field flagged in the templates as having said first content type with said first data set.

18. A method as claimed in claim 17, wherein steps (a) to (c) are repeated for a plurality of data sets, the data sets each having a different content type and a unique identifier tag being generated for each data set.

19. A method as claimed in claim 17, wherein changes to the or each data set are updated automatically in each field flagged as relating to that content type.

20. A method as claimed in claim 17, wherein the different templates generate one or more of the following: a website, an electronic publication, a printed publication, a newsletter and an e-mail.

21. A method as claimed in claim 17, wherein said first data set comprises one or more of the following: image data, animation data and text data.

22. A method as claimed in claim 17, wherein changes to the first data set include modifying image data.

23. A system for sharing data across a range of different templates, the system comprising a tag generator for generating a first identifier tag to identify a first data set as having a first content type; at least one processor for flagging one or more fields in each of said templates as relating to said first content type; wherein the at least one processor is operative to populate each field flagged in the templates as having said first content type with said first data set.

24. A method of generating online material and print material, the method comprising the steps of:
(a) selecting a first template for the online material and a second template for the print material;
(b) modifying one or more data sets in said first template and/or said second template using a common editor; and
(b) outputting the online material and the print material in a common file format.

25. A system for generating online material and print material, the system comprising a storage device on which at least a first template for online material and a second template for print material are stored; processing means adapted to enable one or more data sets in said first template and/or said second template to be modified using a common editor; the processing means being adapted to generate the online material and the print material in a common file format.
